(19) United States
(12) Patent Application Publication
(10) Pub. No.: US 2003/0002703 A1
(43) Pub. Date: Jan. 2, 2003

(54) Reflection type of earphone

(76) Inventor: Hsi Kuang Ma, Taipei (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/904,518

(22) Filed: Jul. 16, 2001

(30) Foreign Application Priority Data
Jun. 27, 2001 (TW) 090210753

(51) Int. Cl. H04R 25/00

(52) U.S. Cl. 381/371; 381/370; 381/160

(57) ABSTRACT

A reflection type of earphone comprises a pair of wires, a loudspeaker, and a reflection disk. The wires have an end thereof connecting with a sound signal output of a connected device and the other end thereof connects with the loudspeaker. The loudspeaker provides a sound output. The reflection disk faces to the sound output and has a plurality of bent strips to engage with the loudspeaker. The reflection disk is arranged to close to an acoustic meatus of an user such that the sound can be reflected by way of the reflection disk before entering the acoustic meatus to obtain a time postpone.

### BACKGROUND OF THE INVENTION

1. Field of the Invention

The present invention relates to a reflection type of earphone, and particularly to an earphone with a reflection disk to enhance the quality of sound received in the acoustic meatus.

2. Description of Related Art

The earphone has been utilized for years to listen to sound signal. Due to the privacy in use, the sound signal output from the earphone can be listened by the user personally only without interfering neighbors so that the earphone is widely accompanied with the radio, the WALKMAM, and other audio products.

Generally, the earphone provides a magnet to produce an effect of magnetic field such that a membrane is vibrated by the magnetic field and forms a sound signal to transmit into the acoustic meatus as shown in FIG. 1. It can be seen in FIG. 1 that wires A is connected to a loudspeaker B to make a vibration membrane C vibrate and a sound C is generated to enter a acoustic meatus D. The earphone can be classified into an ear shield type, a plug type, and a headphone type in accordance with the external part thereof.

Although the conventional earphone can perform a basic function of receiving a sound, it gets involved in a defect that the sound output transmits into the acoustic meatus directly. Under this condition, it is lack of an effect of sound surrounding in addition to a heavier impact sound and it is like the ear is attached to the cabinet at the outlet of the loudspeaker so that the sound effect generated naturally is worse than the ear is a distance from the cabinet.

### SUMMARY OF THE INVENTION

An object of the present invention is to provide a reflection type of earphone, which has a reflection disk therein and the sound signal can be reflected before entering the acoustic meatus so as to enhance the sound quality and an effect of sound surrounding.

### BRIEF DESCRIPTION OF THE DRAWINGS

The present invention can be more fully understood by referencing to the following detailed description and accompanying drawings, in which:

FIG. 1 is a plan view of earphone;

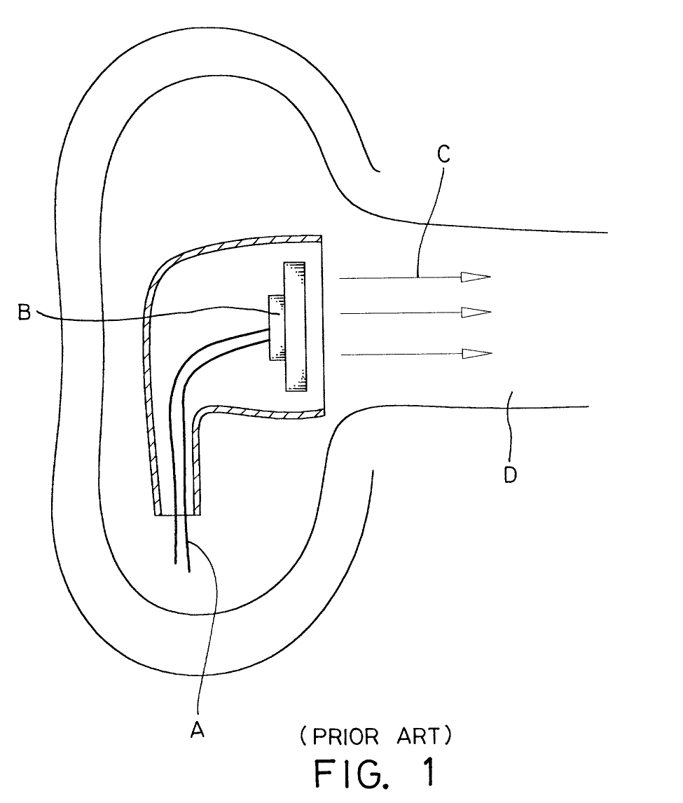

FIG. 2 is a plan view of a reflection type of earphone according to present invention; and

FIG. 3 is a perspective view of a reflection type of earphone according to the present invention.

### DETAILED DESCRIPTION OF THE PREFERRED EMBODIMENTS

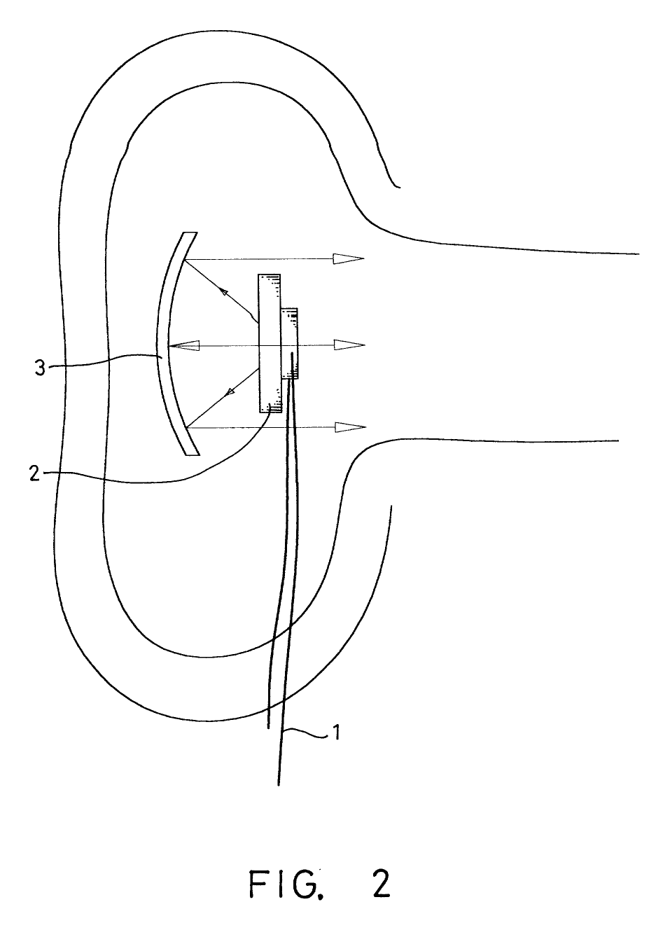

Referring to FIG. 2, a reflection type of earphone according to the present invention basically comprises a pair of wires 1, a loudspeaker 2, and a reflection disk 3.

Wherein, the wires 1 are conventional with an end thereof connecting with the loudspeaker 2 and the other end thereof connecting with a sound signal output such as a WALKMAN. Because the sound signal output is conventional art, no detail will be described further.

The loudspeaker 2 is conventional too with an end thereof connecting with the wires 1, and has element parts such as a magnet and vibration membrane to convert the sound signal to a sound output.

The earphone of the present invention differs from the conventional earphone in that the loudspeaker 2 at the outer side of the output end provides a reflection disk 3. The reflection disk 3 preferably has a smooth curve surface so that the sound can be reflected. A plurality of bent strips 31 between the reflection disk 3 and the loudspeaker 2 such that the reflection disk 3 can be fixedly in conjunction with the loudspeaker 2.

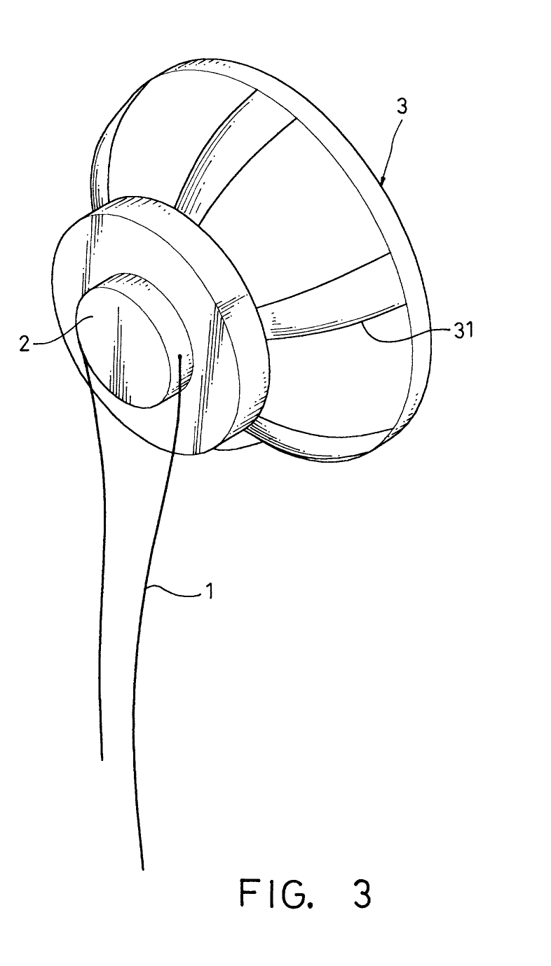

Referring to FIGS. 2 and 3 again, while the earphone in use, the wires 1 connect with the sound signal output such as the WALKMAN first. Then, the reflection disk 3 is arranged to close to the acoustic meatus. The sound output may be transmitted to the reflection disk 3 and then be reflected into the acoustic meatus by the reflection disk 3 so that the listener can receive the sound signal.

Because the sound output is reflected by way of the refection disk 3 before entering the acoustic meatus instead of entering the acoustic meatus directly, an effect of time postpone can be obtained so that the sound sensed by the user is more deep-going than the conventional earphone. Thus, the sound quality listened through the earphone of the present invention is much more sound surrounding.

It is noted that the reflection earphone can have different configurations depending on different coverings such as earplug type, ear shield type, hanging type, and etc. However, the differences are belonged to an addition of parts and easily thought by the persons with skill in the art. Thus, no detail will be described further.

While the invention has been described with reference to a preferred embodiment thereof, it is to be understood that modifications or variations may be easily made without departing from the spirit of this invention, which is defined by the appended claims.

What is claimed is:

1. A reflection type of earphone, comprising:
a pair of wires with two ends, one of the ends connecting with a sound signal output of a connected device;
a loudspeaker with an end, the end is connected to the other one of the ends of the wires, and providing a sound output; and
a reflection disk, facing to the sound output, and having a plurality of bent strips to engage with the loudspeaker;
whereby, the reflection disk is arranged to close to an acoustic meatus of an user such that the sound can be reflected by way of the reflection disk before entering the acoustic meatus to obtain a time postpone.

2. The reflection type of earphone according to claim 1, wherein the reflection disk has a curve.

3. The reflection type of earphone according to claim 1, the reflection disk has a smooth reflection surface.

4. The reflection type of earphone according to claim 1, an outer part of the earphone can be covered.
